(19) United States
(12) Patent Application Publication
(10) Pub. No.: US 2026/0084676 A1
(43) Pub. Date: Mar. 26, 2026

(54) METHODS AND APPARATUS TO MONITOR A CONDITION OF A BRAKING SYSTEM

(71) Applicant: Ford Global Technologies, LLC, Dearborn, MI (US)

(72) Inventors: Anuj Pal, Saint Paul, MN (US); Ritik Singh, Mooresville, NC (US); Satheesh Kumar Chandran, Livonia, MI (US); Victoria Svidenko, Newcastle, WA (US)

(21) Appl. No.: 18/891,612

(22) Filed: Sep. 20, 2024

(51) Int. Cl. B60T 17/22

(52) U.S. Cl. CPC B60T 17/22; B60T 2250/04

(57) ABSTRACT

Disclosed examples include measuring, via a sensor, a brake torque generated by a braking system; determining an energy output of the braking system based on a mechanical power output of the braking system, the mechanical power output based on the brake torque; determining an efficiency based on the energy output and an energy input, the energy input corresponding to an electrical power input of a motor of the braking system; detecting a condition of the braking system based on the efficiency; and outputting an indication representative of the condition.

### FIELD OF THE DISCLOSURE

This disclosure relates generally to vehicles and, more particularly, to methods and apparatus to monitor a condition of a braking system.

### BACKGROUND

Some vehicles include a brake-by-wire system. Unlike hydraulic brakes, the electric brakes of brake-by-wire systems slow the rotation of wheels of vehicles via electric actuators. Some electric brake systems (EBS) are configured such that, when the driver activates the brakes (e.g., via a brake pedal, etc.), an electrical command is sent to the actuators of the brakes, thereby causing a braking force to be applied to the wheels.

### SUMMARY

An example apparatus comprises machine-readable instructions, and at least one processor circuit to be programmed by the machine-readable instructions to measure, via a sensor, a brake torque generated by a braking system, determine an energy output of the braking system based on a mechanical power output of the braking system, the mechanical power output based on the brake torque, determine an efficiency based on the energy output and an energy input, the energy input corresponding to an electrical power input of a motor of the braking system, detect a condition of the braking system based on the efficiency, and output an indication representative of the condition.

At least one example non-transitory machine-readable medium comprises machine-readable instructions to cause at least one processor circuit to at least measure, via a sensor, a first speed and a second speed of a vehicle, the first speed corresponding to a start of a braking event, the second speed corresponding to an end of the braking event, determine an energy output of a braking system based on the first speed and the second speed, determine an efficiency based on the energy output and an energy input, the energy input corresponding to an electrical power input of a motor of the braking system, detect a condition of the braking system based on the efficiency, and output an indication representative of the condition.

An example method comprises measuring, via a sensor, a brake torque generated by a braking system, determining an energy output of the braking system based on a mechanical power output of the braking system, the mechanical power output based on the brake torque, determining an efficiency based on the energy output and an energy input, the energy input corresponding to an electrical power input of a motor of the braking system, detecting, by at least one processor circuit programmed by at least one instruction, a condition of the braking system based on the efficiency, and outputting an indication representative of the condition.

### BRIEF DESCRIPTION OF THE DRAWINGS

FIG. 1 is a perspective view of a vehicle in which examples disclosed herein can be implemented.

FIG. 2 is a front view of an example brake assembly of the vehicle of FIG. 1.

FIG. 3 is a rear view of the example brake assembly of FIG. 2.

FIG. 4 is an example electro-mechanical brake (EMB) actuation chain of the brake assembly of FIGS. 2 and 3.

FIG. 5 is a block diagram of the example brake assembly of FIGS. 2 and 3.

FIG. 6 is an example actuation chain degradation versus braking efficiency graph.

FIG. 7 illustrates example operating boundaries depicting an in-range condition and out-of-range conditions for the EMB actuation chain of FIGS. 4 and 5.

FIG. 8 is a block diagram of an example implementation of the brake controller of FIGS. 1 and 5.

FIG. 9 is a flowchart representative of example machine-readable instructions and/or example operations that may be executed, instantiated, and/or performed by example programmable circuitry to implement the brake controller of FIG. 8 to detect a condition of a braking system using braking efficiency based on a brake torque.

FIGS. 10A and 10B illustrate a flowchart representative of example machine-readable instructions and/or example operations that may be executed, instantiated, and/or performed by example programmable circuitry to implement the brake controller of FIG. 8 to detect a condition of a braking system using braking efficiency based on kinetic energy and energy losses of a vehicle.

FIG. 11 is a block diagram of an example processing platform including programmable circuitry structured to execute, instantiate, and/or perform the example machine-readable instructions and/or perform the example operations of FIG. 9 and/or FIGS. 10A and 10B to implement the brake controller of FIG. 8.

FIG. 12 is a block diagram of an example implementation of the programmable circuitry of FIG. 11.

FIG. 13 is a block diagram of another example implementation of the programmable circuitry of FIG. 11.

In general, the same reference numbers will be used throughout the drawings and accompanying written description to refer to the same or like parts. The figures are not necessarily to scale.

### DETAILED DESCRIPTION

Examples disclosed herein relate to EMB systems in a drive-by-wire approach to braking. In examples disclosed herein, an actuation chain of a braking system refers to a brushless direct current (BLDC) motor and gearing components that convert electrical energy input to mechanical energy output that produces a brake torque at a wheel. Examples disclosed herein may be used to monitor a condition of a braking system and detect a condition of one or more components in the braking system actuation chain. For example, a braking efficiency of a braking system can be determined and used to identify whether an actuation chain of the braking system is operating in an in-range condition or an out-of-range condition. As used herein, braking efficiency represents how effectively electrical energy provided (e.g., electrical energy input) to a braking system actuation chain is converted to produce a desired or target brake torque (e.g., mechanical energy output). In examples disclosed herein, an in-range condition represents that the braking system is operating as intended. In examples disclosed herein, an out-of-range condition represents that the braking system is outside of an optimal performance boundary. Out-of-range conditions may be attributed to poor lubrication of components, worn components, broken components, etc. leading to decreased braking efficiency of the braking system. In some examples, a first-level out-of-range condition corresponds to an inspection status condition that notifies a driver and/or maintenance specialist to inspect the brake system. In some examples, a second-level out-of-range condition corresponds to a service status condition that notifies a driver and/or maintenance specialist that the braking system likely needs maintenance (e.g., lubrication, repair, part replacement(s), etc.).

A brake-by-wire system uses a closed loop control in which a requested “Brake Torque_target” (e.g., relative to a pressing force on a brake pedal) is input into the brake-by-wire closed loop. The closed loop generates an electrical current input (i_in) to the brake actuator motor based on the “Brake Torque_target” and uses the electrical current input (i_in) to cause a spread unit or a caliper to create a braking torque between brake pads and a braking surface (e.g., a brake drum, a brake rotor, etc.). Over time, the amount of energy used to generate sufficient braking torque to satisfy the “Brake Torque_target” increases. As this energy increases for the same target brake torque, the braking efficiency of the brake system decreases. Examples disclosed herein monitor the braking efficiency and detect when that braking efficiency falls below a threshold. When the braking efficiency falls below the threshold, examples disclosed herein generate a notification or alert corresponding to an out-of-range condition of the brake system.

Examples disclosed herein use two trendlines of braking efficiency versus actuation chain condition. A maximum at-rest gap trendline represents braking efficiencies and corresponding actuation chain condition of a brake system when an at-rest friction material-to-braking surface gap is at a maximum distance. In examples disclosed herein, “at-rest” refers to a positional state of a friction material on a brake shoe or brake pad during which the brake shoe or brake pad is not being driven toward a braking surface (e.g., a brake drum or brake rotor) regardless of whether the vehicle is moving. A minimum at-rest gap trendline represents braking efficiencies and corresponding actuation chain conditions of a brake system when the at-rest friction material-to-braking surface gap is at a minimum distance.

In examples disclosed herein, braking efficiencies are determined per braking event. In some examples disclosed herein, braking efficiency can be determined based on actual brake torques created by a braking system. In other examples disclosed herein, braking efficiency can be determined based on energy losses pertaining to different aspects of a vehicle. As used herein, a braking event lasts for the duration starting from the time at which a request to generate a target brake torque is received from a driver (e.g., engaging or pressing of a brake pedal) and ending when the request for a brake torque ends (e.g., the brake pedal is released or is no longer pressed). A braking event may include multiple iterations of a feedback control loop to achieve a requested target brake torque by controlling an amount of actual brake torque applied by brake shoes or brake pads.

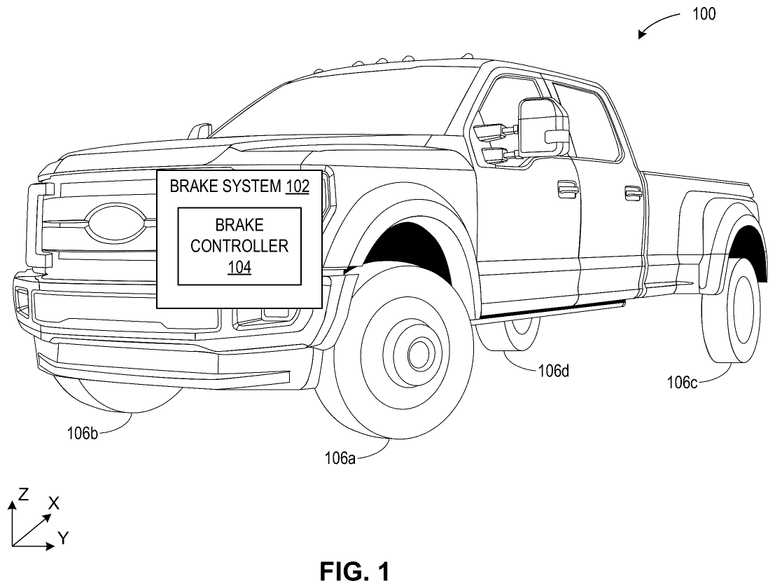

FIG. 1 is a perspective view of an example vehicle 100 in which examples disclosed herein can be implemented. In the illustrated example of FIG. 1, the vehicle 100 includes an example brake system 102, an example brake controller 104, an example first wheel 106a, an example second wheel 106b, an example third wheel 106c, and an example fourth wheel 106d.

The vehicle 100 is a motorized wheel-driven vehicle. In the illustrated example of FIG. 1, the vehicle 100 is a pick-up truck. In other examples, the vehicle 100 can be any type of vehicle with brakes (e.g., a sedan, a coupe, a van, a pick-up truck, a sports utility vehicle, an all-terrain vehicle (ATV), farming equipment, etc.). The vehicle 100 may be a fully electric vehicle, a hybrid vehicle including an internal combustion engine and electrical drive components, or an internal combustion engine (e.g., a non-electrified vehicle, a partially electrified vehicle, etc.).

In the illustrated example of FIG. 1, the brake system 102 is implemented as an EMB system that uses a brake-by-wire system. The brake system 102 includes mechanical and electrical components that slow down the rotation of the wheels 106a, 106b, 106c, 106d. The brake system 102 can receive user input (e.g., via a brake pedal, a parking brake lever/switch/pedal, etc.) or machine input (e.g., an automated command of a vehicle automation system, etc.) and cause activation of one or more brake(s) of the brake system 102.

The wheels 106a, 106b, 106c, 106d include a wheel rim and a corresponding tire. While in the illustrated example of FIG. 1, the vehicle 100 has two axles and four wheels, in other examples, the vehicle 100 can have any number of axles and wheels. In the illustrated example of FIG. 1, the first wheel 106a and the second wheel 106b are front wheels and the third wheel 106c and the fourth wheel 106d are rear wheels. In the illustrated example of FIG. 1, the first wheel 106a and the third wheel 106c are driver-side wheels and the second wheel 106b and the fourth wheel 106d are passenger-side wheels.

During the operation of the vehicle 100, the brake system 102 is controlled via the brake controller 104. For example, in response to a user input (e.g., the depression of a brake pedal, etc.) and/or a machine input (e.g., an automated command of a vehicle automation system, etc.), the brake controller 104 can cause the brake system 102 to slow down the rotation of some or all of the wheels 106a, 106b, 106c, 106d, thereby slowing the vehicle 100.

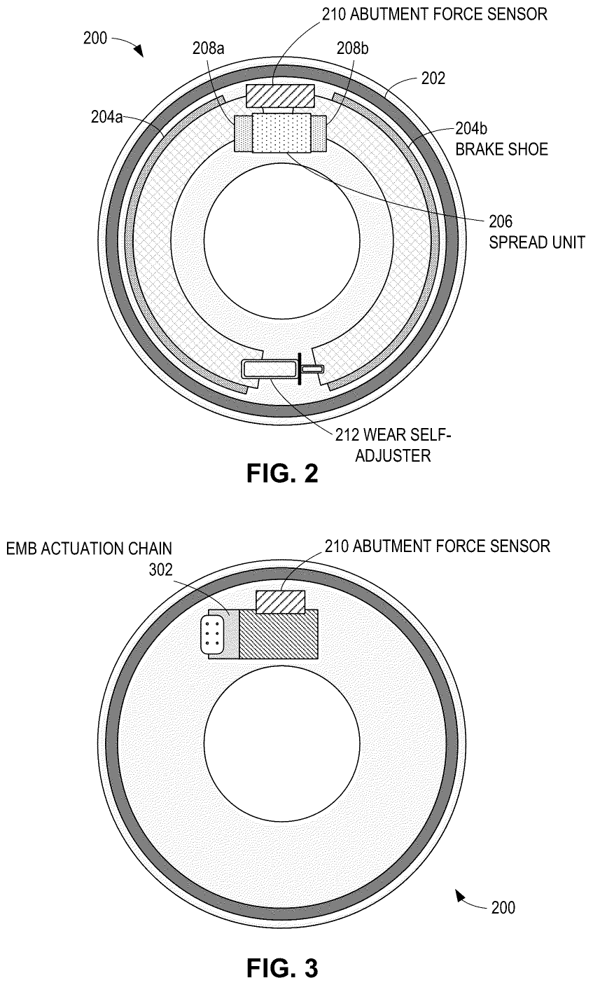

FIG. 2 is a front view of an example brake assembly 200 that may be used to implement the brake system 102 of the vehicle 100 of FIG. 1. The brake assembly 200 corresponds to one of the wheels 106a-d of the vehicle 100. Although examples disclosed herein are described relative to the brake assembly 200 being implemented by a drum brake assembly, examples disclosed herein may additionally or alternatively be used in connection with disc brake assemblies. In some examples, each of the wheels 106a-d includes a drum brake assembly substantially similar or identical to the brake assembly 200. In other examples, only some of the wheels 106a-d include drum brake assemblies and others of the wheels 106a-d include disc brake assemblies. For example, the rear wheels 106c, d may include drum brake assemblies and the front wheels 106a,b may include disc brake assemblies. In such brake configurations, examples disclosed herein may be implemented for the drum brake assemblies and the disc brake assemblies. In yet other examples, all of the wheels 106a-d include disc brake assemblies and examples disclosed herein may be implemented for the disc brake assemblies.

Although a single EMB actuation chain 302 is shown in connection with one brake assembly 200 of one of the wheels 106a-d, EMB actuation chains substantially similar or identical to the EMB actuation chain 302 can be provided to all of the wheels 106a-d. Accordingly, examples disclosed herein can be implemented to monitor for out-of-range conditions of all of the EMB actuation chains of the vehicle 100. As such, the EMB actuation chain of each of the wheels 106a-d can be monitored separately and separate out-of-range condition notifications can be raised or output for each EMB actuation chain independent of others of the EMB actuation chains of the vehicle 100.

The brake assembly 200 includes a drum 202 that rotates in unison with a corresponding wheel (e.g., one of the wheels 106a-d). As such, rotational acceleration and speed of the drum 202 matches the rotational acceleration and speed of the corresponding wheel. Therefore, a deceleration force applied against an inner surface of the drum 202 translates to commensurate deceleration of the wheel. Similarly, in a disc brake assembly, a disc brake rotor operates substantially similar to the drum 202 in that it rotates in unison with a corresponding wheel (e.g., one of the wheels 106a-d) such that rotational acceleration and speed of the rotor matches the rotational acceleration and speed of the corresponding wheel. As such, a deceleration force applied against a disc surface of the disc brake rotor translates to commensurate deceleration of the wheel. The inner surface of the drum 202 in the brake assembly 200 and a disc surface of a disc brake rotor in a disc brake assembly can be generally referred to as braking surfaces.

The brake assembly 200 includes example opposing brake shoes identified as a first brake shoe 204a and a second brake shoe 204b. The brake shoes 204a,b have respective friction material surfaces that create deceleration forces when the friction material surfaces engage the inner surface of the drum 202 based on an applied brake torque. In a disc brake assembly, opposing brake pads in a brake caliper assembly also have respective friction material surfaces. Deceleration forces are created when the brake caliper assembly squeezes the brake pads together so that their friction material surfaces engage opposing disc surfaces of a disc brake rotor based on an applied brake torque.

The brake assembly 200 also includes an example spread unit 206. The spread unit 206 is mechanically coupled to the opposing brake shoes 204a,b. The spread unit 206 includes two opposing pistons 208a,b. In operation, the spread unit 206 is activated to push the pistons 208a,b away from one another in opposite directions. As such, the pistons 208a,b push the brake shoes 204a,b (FIG. 2) away from one another to engage the inner surface of the drum 202. When the spread unit 206 pushes the brake shoes 204a,b toward the inner surface of the drum 202, the friction material surfaces of the brake shoes 204a,b engage the inner surface of the drum 202 to generate an applied brake torque between the brake shoes 204a,b and the drum 202 (e.g., an actual brake torque between the friction material surfaces of the brake shoes 204a,b and the braking surface of the drum 202). This action slows the rotation of a corresponding one of the wheels 106a-d through frictional forces.

In a disc brake assembly, a brake caliper includes one or more brake caliper pistons that push one brake pad towards an opposing brake pad to engage opposing disc surfaces of a disc brake rotor. The brake caliper and the brake caliper piston(s) operate in a disc brake assembly to create an applied brake torque between opposing brake pads and the disc brake rotor. As such, applied brake torque can be generated by the spread unit 206 in the brake assembly 200 and generated by a brake caliper in a disc brake assembly. The pistons 208a,b of the spread unit 206 in the brake assembly 200 and brake caliber pistons of a brake caliper in a disc brake assembly can be generally referred to as brake pistons.

The brake assembly 200 includes an example abutment force sensor 210. The abutment force sensor 210 measures the amount of torque that is actually applied by the brake shoes 204a,b against the drum 202. For example, the spread unit 206 can be actuated based on an applied or requested target brake torque (e.g., through the pressing of a brake pedal, through an automated command of a vehicle automation system, etc.). However, the actual torque applied by the brake shoes 204a,b against the drum 202 may be different from the requested target brake torque. Such difference may be due to wearing of components in a brake system. As the wear increases over time, the amount of input current needed by the brake system to generate a requested target brake torque at the brake shoes 204a,b also increases. Therefore, the actual brake torque is measured by the abutment force sensor 210 and used in a feedback control loop to more accurately control the amount of actual brake torque applied by the brake shoes 204a,b based on a requested target brake torque.

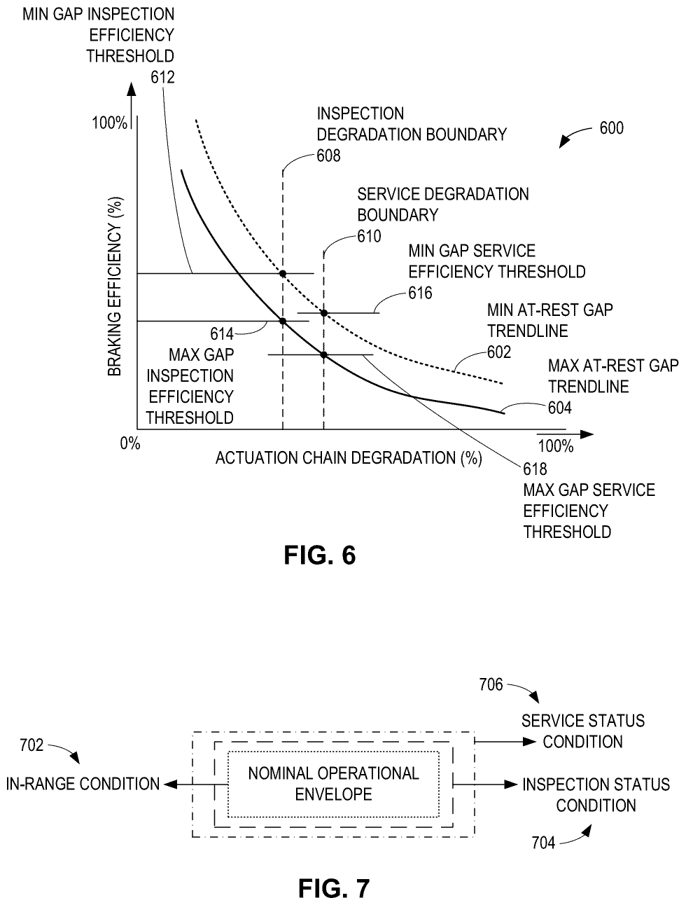

The brake assembly 200 includes an example wear self-adjuster 212. The wear self-adjuster 212 compensates for wearing of friction material on the brake shoes 204a,b over time. As such friction material wear increases throughout the life of the brake shoes 204a,b, an at-rest gap between the brake shoes 204a,b and the inner surface of the drum 202 also increases. The wear self-adjuster 212 mitigates for some of the friction material wear by urging the brake shoes 204a,b closer to the drum 202 as the friction material thickness decreases. However, differences in at-rest gaps between the brake shoes 204a,b and the inner surface of the drum 202 can still arise relative to a new condition (e.g., little or no friction material wear) of the brake shoes 204a,b and a worn condition (e.g., noticeable friction material wear) of the brake shoes 204a,b. Such differences in at-rest gaps are described below in connection with a minimum at-rest gap trendline (e.g., the minimum at-rest gap trendline 602 of FIG. 6) and a maximum at-rest gap trendline (e.g., the maximum at-rest gap trendline 604 of FIG. 6).

FIG. 3 is a rear view of the example brake assembly 200 of FIG. 2. In example FIG. 3, the brake assembly 200 includes the example EMB actuation chain 302 (e.g., an EMB actuator system) mounted thereto. In addition, the abutment force sensor 210 is engaged with the EMB actuation chain 302. The EMB actuation chain 302 is communicatively coupled to the brake controller 104 of FIG. 1. In operation, the brake controller 104 sends brake actuation signals (e.g., electrical current input (i_in)) to the EMB actuation chain 302, and the EMB actuation chain 302 generates actual brake torques between the brake shoes 204a,b and the drum 202. Measurement feedback signals of the actual brake torques are provided by the abutment force sensor 210 to the brake controller 104. The brake controller 104 uses the applied brake torque measurement feedback signals to provide corrective brake actuation signals (e.g., electrical current input (i_in)) to the EMB actuation chain 302. This feedback and corrective process is performed repeatedly while a target brake torque is requested by a vehicle operator or a vehicle automation system so that actual brake torque produced at the brake assembly 200 by the EMB actuation chain 302 can satisfy the target brake torque.

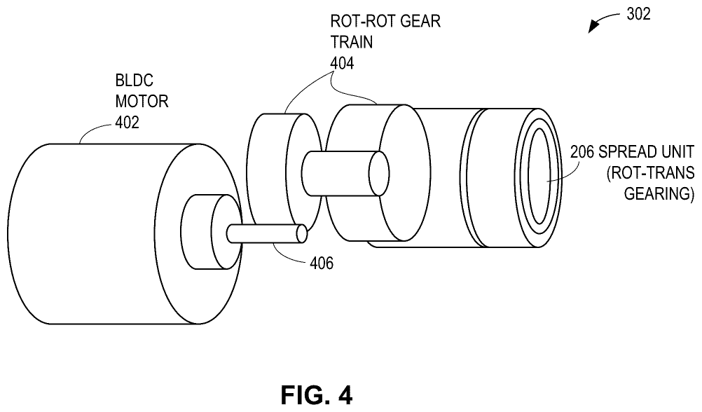

FIG. 4 is the example EMB actuation chain 302 of FIG. 3. The EMB actuation chain 302 includes an example BLDC motor 402 operatively coupled to the spread unit 206 of FIG. 2 via an example rotational-rotational gear train 404. The BLDC motor 402 includes an example shaft 406 extending therefrom. The shaft 406 of the BLDC motor 402 provides rotational force to drive the pistons 208a,b (FIG. 2) of the spread unit 206 away from one another to increase brake torque during a braking event or closer to one another to reduce brake torque or to end the braking event.

The BLDC motor 402 operates as the actuator for braking and is controlled by the brake controller 104 of FIGS. 1 and 2. For example, in response to a target brake torque request from a vehicle operator or a vehicle automation system, the brake controller 104 sends a brake actuation signal (e.g., electrical current input (i_in)) to the EMB actuation chain 302. In response, the EMB actuation chain 302 causes rotation of the shaft 406 of the BLDC motor 402. The spread unit 206 receives the rotational motion from the rotational-rotational gear train 404 and converts the rotational motion to linear motion. In examples disclosed herein, the spread unit 206 implements a rotational-translational (rot-trans) gear train between the rotational-rotational gear train 404 and the pistons 208a,b. The linear motion drives the pistons 208a,b of the spread unit 206 to push the brake shoes 204a, b into engagement with the inner surface of the drum 202 to produce a clamp force. In this manner, the EMB actuation chain 302 produces a desired brake torque (e.g., a target brake torque) against the drum 202 to slow the wheels 106a-d of the vehicle 100 of FIG. 1.

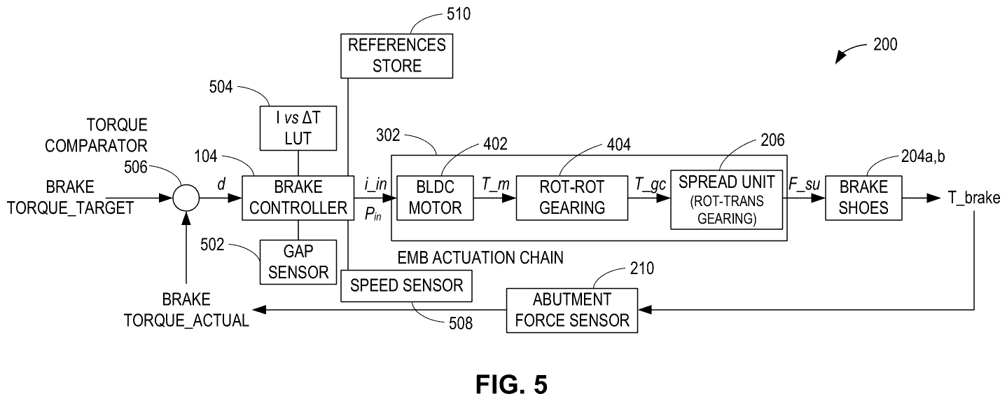

FIG. 5 is a block diagram of an example implementation of the example brake assembly 200 of FIGS. 2 and 3 to monitor the condition of the EMB actuation chain 302. The monitoring involves out-of-range condition detection based on braking efficiency of the EMB actuation chain 302. Such monitoring can be implemented during braking events to detect a condition of the EMB actuation chain 302. The block diagram of FIG. 5 represents a closed loop control system in which a target brake torque (Brake Torque_target) is provided for a braking event and the actual applied brake torque (T_brake) is measured (Brake Torque_actual) to iteratively control the amount of applied brake torque until the applied brake torque matches the input target brake torque.

In the illustrated example of FIG. 5, the brake controller 104 of FIG. 1 is communicatively coupled to the EMB actuation chain 302 and the EMB actuation chain 302 is coupled to the brake shoes 204a,b. In the example of FIG. 5, the EMB actuation chain 302 includes the BLDC motor 402, the rotational-rotational gear train 404, and the spread unit 206 (e.g., the rotational-translational gear train). The brake assembly 200 also includes an example gap sensor 502, an example electrical current (I) versus torque change (ΔT) look-up-table (LUT) 504, example torque comparator circuitry 506, an example speed sensor 508, and an example references store 510.

The gap sensor 502 is provided to detect friction material-to-braking surface gap sizes between the brake shoes 204a,b (or brake pads) and a braking surface of the drum 202 (or a braking surface of a disc rotor). In some examples, the gap sensor 502 may be omitted and the friction material-to-braking surface gap sizes may be determined or inferred using other techniques. For example, the friction material-to-braking surface gap sizes may be inferred from the amount of electrical current input values (i_in) used to generate a target brake torque. In some examples, the references store 510 stores electrical current input versus brake torque data (e.g., an electrical current input versus brake torque curve) that can be used to infer friction material-to-braking surface gap sizes.

The I versus ΔT LUT 504 is provided to store electrical current input values (i_in) (e.g., for the BLDC motor 402) in association with corresponding target brake torque values (Brake Torque_target). In operation, the brake controller 104 receives a target brake torque value (Brake Torque_target) based on, for example, the pressing of a brake pedal, an automated command of a vehicle automation system, etc. To drive the BLDC motor 402 based on the target brake torque value (Brake Torque_target), the brake controller 104 accesses the I versus ΔT LUT 504 to retrieve an electrical current value corresponding to a change in torque amount to generate the target brake torque value. That is, the retrieved electrical current value is intended to drive the BLDC motor 402 to cause the spread unit 206 to produce an applied brake torque (T_brake) substantially equal to the target brake torque value (Brake Torque_target). To do so, the brake controller 104 generates an electrical current input (i_in) based on the electrical current value retrieved from the I versus ΔT LUT 504 and drives the BLDC motor 402 using the generated electrical current input (i_in).

When the spread unit 206 is not actively pushing the brake shoes 204a,b, the change in torque amount (ΔT) to generate the target brake torque is equal to the target brake torque value (Brake Torque_target). However, when the spread unit 206 is actively pushing the brake shoes 204a,b, the change in torque amount (ΔT) to generate the target brake torque is equal to the amount of additional torque needed to increase a presently applied brake torque (T_brake) to satisfy the target brake torque value (Brake Torque_target).

Based on the electrical current input (i_in), the BLDC motor 402 produces a corresponding motor torque, or rotational torque force, (T_m) via its shaft 406 (FIG. 4). The shaft 406 transfers the rotational torque force (T_m) to the rotational-rotational gear train 404. The rotational-rotational gear train 404 operates as a torque multiplier to increase the rotational torque force (T_m) from the shaft 406. As such, the rotational-rotational gear train 404 generates a rotational gear chain torque (T_gc) (e.g., torque output from the rotational-rotational gear train 404) based on the rotational torque force (T_m) and transfers the rotational gear chain torque (T_gc) to the spread unit 206.

The spread unit 206 converts the rotational gear chain torque (T_gc) to a translational (linear) spread unit force (F_su) (e.g., a force output from the spread unit 206). The spread unit 206 uses the translational (linear) spread unit force (F_su) to drive the opposing pistons 208a,b (FIG. 2) away from one another. In turn, the pistons 208a,b push the brake shoes 204a,b in opposite directions and into engagement with the inner surface of the drum 202 to generate a brake torque (T_brake) (e.g., an actual brake torque) between the brake shoes 204a,b and the drum 202. If the vehicle 100 is in motion, the brake shoes 204a,b rub against the drum 202 to slow rotation of the drum 202. If the vehicle 100 is at a standstill, the brake shoes 204a,b press against the drum 202 to prevent rotation of the drum 202 (e.g., in a parking brake application).

The brake assembly 200 is provided with the torque comparator circuitry 506 to compare the target brake torque (Brake Torque_target) to actual brake torque (Brake Torque_actual) measurements. For example, the abutment force sensor 210 measures the actual brake torque (T_brake) applied by the brake shoes 204a,b against the drum 202 and communicates feedback of an actual brake torque value (Brake Torque_actual) to the torque comparator circuitry 506. To ensure a correct brake torque is generated, the torque comparator circuitry 506 compares the actual brake torque (Brake Torque_actual) feedback to the target brake torque (Brake Torque_target) and generates a torque difference value (d). The torque comparator circuitry 506 provides the torque difference value (d) to the brake controller 104 which uses the torque difference value (d) to adjust the electrical current input (i_in) to the BLDC motor 402 until the actual brake torque (T_brake) satisfies the target brake torque (Brake Torque_target). For example, the brake controller 104 can determine that the actual brake torque (T_brake) satisfies the target brake torque (Brake Torque_target) when the torque difference value (d) is less than or equal to a torque difference tolerance value. The torque difference tolerance value may be selected to be any suitable value (e.g., within 1%, 2%, etc.) that results in an acceptable actual brake torque (T_brake) relative to the target brake torque (Brake Torque_target). The torque comparator circuitry 506 may be implemented by hardware alone or by hardware in combination with software and/or firmware.

The brake assembly 200 is provided with the speed sensor 508 to measure the speed of the vehicle 100. For example, the speed sensor 508 may be coupled to a speedometer of the vehicle 100. In some examples, the speed sensor 508 is implemented using an angular velocity that measures an angular velocity, or speed, of a wheel. For example, the speed sensor 508 may measure a rate of rotation of a wheel which may then be used to determine the speed of the vehicle 100. Accordingly, the speed sensor 508 determines wheel speed, or wheel angular velocity, which is used to determine the vehicle speed of the vehicle 100.

For a particular target brake torque (Brake Torque_target), the BLDC motor 402 draws a certain amount of electrical power input (Pᵢₙ). A reduction in braking efficiency occurs when electrical power input (Pᵢₙ) increases to generate a target brake torque (Brake Torque_target) that was previously produced using less electrical power input (Pᵢₙ). To perform out-of-range condition detection based on braking efficiencies of the EMB actuation chain 302, the brake controller 104 is programmed based on the premise that the BLDC motor 402 is not likely to need service for some amount of operating mileage or operating time. Such mileage or time can be referred to as the expected BLDC motor life. In any case, while the BLDC motor 402 is operating within its expected BLDC motor life, calculated braking efficiencies are attributed to other components of the EMB actuation chain 302 (e.g., the rotational-rotational gear chain 404 and the spread unit 206). In some examples, while the BLDC motor 402 is operating within its expected BLDC motor life, detected out-of-range conditions of the EMB actuation chain 302 can result in alerts or notifications that attribute the detected out-of-range conditions to components of the EMB actuation chain 302 (e.g., mechanical components such as gearings, pistons, lubricant, etc.) other than the BLDC motor 402. However, when the BLDC motor 402 is operating beyond its expected BLDC motor life, detected out-of-range conditions of the EMB actuation chain 302 can result in alerts or notifications that attribute the detected out-of-range conditions to be attributed to the BLDC motor 402 or any other component (e.g., mechanical components such as gearings, pistons, lubricant, etc.) of the EMB actuation chain 302.

Because the BLDC motor 402 is current-controlled, examples disclosed herein determine braking efficiency based on the electrical current drawn by the BLDC motor 402. The electrical current draw, electrical power input (Pᵢₙ), and braking efficiency depend on the gap between the brake shoes 204a,b and the inner surface of the drum 202 and, in some examples, also depend on the temperature of the BLDC motor 402. To model braking efficiency versus actuation chain degradation for different at-rest friction material-to-braking surface gaps, an example actuation chain degradation versus braking efficiency graph 600 is shown in FIG. 6.

In the illustrated example of FIG. 6, the actuation chain degradation versus braking efficiency graph 600 shows two actuation chain degradation trendlines relative to braking efficiency labelled as an example minimum at-rest gap trendline 602 and an example maximum at-rest gap trendline 604. In examples disclosed herein, “at-rest” refers to a state of the brake shoes 204a,b during which the BLDC motor 402 is not generating torque to spread or push the brake shoes 204a,b toward the drum 202. The minimum at-rest gap trendline 602 represents braking efficiency percentages (%) as measures of electrical energy input to the EMB actuation chain 302 and mechanical energy output from the EMB actuation chain 302 to generate target brake torques when an at-rest friction material-to-braking surface gap is at a minimum (e.g., the wear self-adjuster 212 maintains a minimum gap size between the brake shoes 204a,b and the drum 202). The maximum at-rest gap trendline 604 represents braking efficiency percentages (%) as measures of electrical energy input to the EMB actuation chain 302 and mechanical energy output from the EMB actuation chain 302 to generate target brake torques when the at-rest friction material-to-braking surface gap is at a maximum (e.g., the wear self-adjuster maintains a maximum gap size between the brake shoes 204a,b and the drum 202).

Accordingly, the minimum at-rest gap trendline 602 corresponds to a first gap size between the brake shoes 204a,b and the drum 202 when the brake shoes 204a,b are at rest (e.g., when the brake pistons 208a,b are at rest), and the maximum at-rest gap trendline 604 corresponds to a second gap size between the brake shoes 204a,b and the drum 202 when the brake shoes 204a,b are at rest (e.g., when the brake pistons 208a,b are at rest). The second gap size is bigger than the first gap size. For example, as noted above, the first gap size may correspond to the wear self-adjuster 212 maintaining a minimum gap size between the brake shoes 204a,b and the drum 202, and the second gap size may correspond to the wear self-adjuster 212 maintaining a maximum gap size between the brake shoes 204a,b and the drum 202. In some examples, the minimum at-rest gap trendline 602 corresponds to a relatively newer condition (e.g., little or no friction material wear) of the brake shoes 204a,b and the maximum at-rest gap trendline 604 corresponds to a relatively worn condition (e.g., noticeable friction material wear) of the brake shoes 204a,b.

More generally, the minimum at-rest gap trendline 602 and the maximum at-rest gap trendline 604 can apply to drum brake assemblies or disc brake assemblies. In either case, the maximum at-rest gap trendline 604 can more generally correspond to a first gap size between friction material surfaces (e.g., of the brake shoes 204a,b or brake pads) and braking surfaces (e.g., an inner surface of the drum 202 or opposing disc surfaces of a disc brake rotor) when the brake pistons 208a,b of the brake assembly 200 or brake piston(s) of a disc brake assembly are at rest, and the maximum at-rest gap trendline 604 corresponds to a second gap size between the friction material surfaces and the braking surfaces when the brake pistons 208a,b of the brake assembly 200 or brake piston(s) of a disc brake assembly are at rest.

The data for the trendlines 602, 604 can be determined through experimental or empirical processes in a laboratory, field tests, or other test environments. For example, multiple brake shoes (or brake pads) and corresponding drums (or brake rotors) can be run through multiple braking cycles for both minimum at-rest friction material-to-braking surface gap and maximum at-rest friction material-to-braking surface gap conditions. During the braking cycles, braking efficiency percentages and corresponding actuation chain degradation percentages can be recorded to generate the trendlines 602, 604.

The actuation chain degradation versus braking efficiency graph 600 also includes an example inspection degradation boundary 608 (e.g., an inspection degradation cutoff threshold) and an example service degradation boundary 610 (e.g., a service degradation cutoff threshold) which correspond to different percentages of actuation chain degradation. In examples disclosed herein, the inspection degradation boundary 608 corresponds to an inspection status condition (e.g., a first-level out-of-range condition) that notifies a driver and/or maintenance specialist to inspect the brake system. In examples disclosed herein, the service degradation boundary 610 corresponds to a service status condition (e.g., a second-level out-of-range condition) that notifies a driver and/or maintenance specialist that the braking system likely needs maintenance (e.g., lubrication, repair, part replacement(s), etc.). The inspection degradation boundary 608 can be selected as a percentage of actuation chain degradation that correlates with percentages of braking efficiencies on the trendlines 602, 604 indicative that inspection of the EMB actuation chain 302 is likely warranted. The service degradation boundary 610 can be selected as a percentage of actuation chain degradation that correlates with percentages of braking efficiencies on the trendlines 602, 604 indicative that service (e.g., maintenance and/or repair) of the EMB actuation chain 302 is likely warranted.

In examples disclosed herein, the inspection degradation boundary 608 is selected to be a lower actuation chain degradation percentage than an actuation chain degradation percentage of the service degradation boundary 610. For example, the inspection degradation boundary 608 can be selected to generate an inspection status notification at a 60% actuation chain degradation and the service degradation boundary 610 can be selected to generate a service status notification at a 90% actuation chain degradation. Alternatively, any other suitable actuation chain degradation percentages can be selected for the inspection degradation boundary 608 and the service degradation boundary 610.

To determine when the EMB actuation chain 302 reaches the inspection degradation boundary 608, the actuation chain degradation versus braking efficiency graph 600 also includes an example minimum gap inspection efficiency threshold 612 and an example maximum gap inspection efficiency threshold 614. In the example of FIG. 6, the minimum gap inspection efficiency threshold 612 corresponds to a braking efficiency at which the inspection degradation boundary 608 intersects the minimum at-rest gap trendline 602. Also in the example of FIG. 6, the maximum gap inspection efficiency threshold 614 corresponds to a braking efficiency at which the inspection degradation boundary 608 intersects the maximum at-rest gap trendline 604.

To determine when the EMB actuation chain 302 reaches the service degradation boundary 610, the actuation chain degradation versus braking efficiency graph 600 also includes an example minimum gap service efficiency threshold 616 and an example maximum gap service efficiency threshold 618. In the example of FIG. 6, the minimum gap service efficiency threshold 616 corresponds to a braking efficiency at which the service degradation boundary 610 intersects the minimum at-rest gap trendline 602. Also in the example of FIG. 6, the maximum gap service efficiency threshold 618 corresponds to a braking efficiency at which the service degradation boundary 610 intersects the maximum at-rest gap trendline 604.

The references store 510 of FIG. 5 is provided to store reference values. For example, the references store 510 stores actuation chain degradation percentage values for the inspection degradation boundary 608 and the service degradation boundary 610. In addition, the references store 510 stores braking efficiency percentage values for the minimum gap inspection efficiency threshold 612, the maximum gap inspection efficiency threshold 614, the minimum gap service efficiency threshold 616, and the maximum gap service efficiency threshold 618. The references store 510 also stores other efficiency percentage threshold values corresponding to one or more additional friction material-to-braking surface gap sizes between the minimum at-rest gap size and the maximum at-rest gap size. For example, when use of a brake shoe or brake pad has worn through half of its friction material, a corresponding mid-wear at-rest gap trendline may be located between the minimum at-rest gap trendline 602 and the maximum at-rest gap trendline 604 on the actuation chain degradation versus braking efficiency graph 600. For such examples, a minimum gap inspection efficiency threshold, a maximum gap inspection efficiency threshold, a minimum gap service efficiency threshold, and a maximum gap service efficiency threshold correspond to chain degradation percentage values along the mid-wear at-rest gap trendline (e.g., between the minimum at-rest gap trendline 602 and the maximum at-rest gap trendline 604). Those threshold values are stored in the references store 510. Similarly, the references store 510 can store any number of efficiency threshold values corresponding to a number of at-rest gap trendlines between the minimum at-rest gap trendline 602 and the maximum at-rest gap trendline 604.

FIG. 7 illustrates example operating boundaries depicting an in-range condition and out-of-range conditions for the EMB actuation chain 302 of FIGS. 4 and 5. In the example of FIG. 7, an example in-range condition 702 corresponds to a nominal operational envelope in which the EMB actuation chain 302 operates as intended. The in-range condition 702 corresponds to braking efficiencies of the EMB actuation chain 302 that are greater than (e.g., are not equal to or less than) an inspection efficiency threshold for a corresponding friction material-to-braking surface gap size (e.g., the minimum gap inspection efficiency threshold 612 or the maximum gap inspection efficiency threshold 614 of FIG. 6).

The example of FIG. 7 also includes an example inspection status condition boundary 704 and an example service status condition boundary 706. The inspection status condition boundary 704 represents the inspection degradation boundary 608 of FIG. 6. For example, the inspection status condition boundary 704 corresponds to braking efficiencies of the EMB actuation chain 302 that are greater than (e.g., are not equal to or less than) a service efficiency threshold for a corresponding friction material-to-braking surface gap size (e.g., the minimum gap service efficiency threshold 616 or the maximum gap service efficiency threshold 618 on the service degradation boundary 610 of FIG. 6) but less than an inspection efficiency threshold for a corresponding friction material-to-braking surface gap size (e.g., the minimum gap inspection efficiency threshold 612 or the maximum gap inspection efficiency threshold 614 on the inspection degradation boundary 608). The service status condition boundary 706 represents the service degradation boundary 610. For example, the service status condition boundary 706 corresponds to braking efficiencies of the EMB actuation chain 302 that are less than a service efficiency threshold for a corresponding friction material-to-braking surface gap size (e.g., the minimum gap service efficiency threshold 616 or the maximum gap service efficiency threshold 618 on the service degradation boundary 610).

In some examples, when the braking efficiencies of the EMB actuation chain 302 are less than an efficiency service threshold (e.g., the minimum gap service efficiency threshold 616 or the maximum gap service efficiency threshold 618 on the service degradation boundary 610) corresponding to the service status condition boundary 706, a vehicle diagnostics system may disable, limit, or adjust certain features of the vehicle 100 until the EMB actuation chain 302 is inspected and/or serviced. For example, vehicle speed and/or acceleration may be limited. Additionally or alternatively, power braking may be disabled and replaced by non-power braking that slows the vehicle 100 as effectively as power braking based on more user involvement (e.g., more applied user pressure on a brake pedal).

To detect quality degradation of one or more components of the EMB actuation chain 302, the brake controller 104 identifies reductions in mechanical efficiency of the EMB actuation chain 302 based on calculated braking efficiencies. For example, during operation of the vehicle 100, the brake controller 104 performs out-of-range condition detection by determining braking efficiencies of the EMB actuation chain 302 during braking events. To determine a braking efficiency, the brake controller 104 is configured (e.g., programmed, structured, etc.) to determine an electrical power input of the EMB actuation chain 302 based on Equation 1 below, an energy input based on Equation 2 below, a mechanical power output of the EMB actuation chain 302 based on Equation 3 below, and an energy output based on Equation 4 below. The brake controller 104 then determines the braking efficiency using Equation 5 below based on the energy input from Equation 2 and the energy output from Equation 4.

$${P}_{in} = {( i\_in )}^{2} \times R \qquad ( Equation 1 )$$

$${E}_{in} = \sum {P}_{in} Δ t \qquad ( Equation 2 )$$

$${P}_{out} = \frac{{T}_{actual}^{brake} \times {S}_{vehicle}}{r} \qquad ( Equation 3 )$$

$${E}_{out} = \sum {P}_{out} Δ t \qquad ( Equation 4 )$$

$$efficiency = \frac{{E}_{out}}{{E}_{in}} \times 100 \qquad ( Equation 5 )$$

In Equation 1 above, an electrical power input (Pᵢₙ) to the EMB actuation chain 302 is equal to the square of the electrical current input (i_in) of the BLDC motor 402 (e.g., (i_in)²) multiplied by the resistance (R) of the BLDC motor 402. In operation, as the electrical current input (i_in) to the BLDC motor 402 increases to generate a target brake torque, the electrical power input (Pᵢₙ) drawn by the BLDC motor 402 in the EMB actuation chain 302 increases commensurately. In addition, the windings of the BLDC motor 402 contribute to the resistance (R) of the BLDC motor 402. As such, a temperature increase of the windings increases the resistance (R) of the BLDC motor 402. For example, during operation, the BLDC motor 402 can generate heat which, in turn, increases its resistance (R) during a braking event. As such, the electrical power input (Pᵢₙ) to the BLDC motor 402 of the EMB actuation chain 302 changes over the duration of a braking event in response to increased motor resistance (R).

Energy can be determined by calculating the integral of power (P) for a continuous time interval (t). In examples disclosed herein, the brake controller 104 is programmed to estimate energy input (Eᵢₙ) of the EMB actuation chain 302 using a summation series. For example, in Equation 2 above, an energy input (Eᵢₙ) of the EMB actuation chain 302 is equal to a summation of discrete values of electrical power inputs (Pᵢₙ) over a duration (Δt) of a braking event.

In Equation 3 above, the mechanical power output (Pₒᵤₜ) of the EMB actuation chain 302 is equal to a product of an actual brake torque

$$( {T}_{actual}^{brake} )$$

and a vehicle speed (S_{vehicle})

$$( e . g . , {T}_{actual}^{brake} \times {S}_{vehicle} )$$

(e.g., of the vehicle 100 of FIG. 1) divided by a wheel radius (r) (e.g., a wheel radius (r) of one of the wheels 106a-d of FIG. 1 at which the EMB actuation chain 302 is located). In examples disclosed herein, the mechanical power output (Pₒᵤₜ) is generated between a friction material and a braking surface (e.g., between the friction material surfaces of the brake shoes 204a,b and the braking surface of the drum 202 or between opposing friction material surfaces of disk brake pads and braking surfaces of a disc brake rotor). An example wheel radius (r) is 8.85 inches (e.g., 0.225 meters). However, Equation 3 may be used for any other wheel radius (r).

In Equation 4 above, energy output (Eₒᵤₜ) of the EMB actuation chain 302 is equal to a summation of discrete values of mechanical power outputs (Pₒᵤₜ) over a duration (Δt) of a braking event. In some examples, the energy output (Eₒᵤₜ) is in the form of heat or friction energy produced between a friction material and a braking surface. In Equation 5 above, braking efficiency is equal to the quotient of energy input (Eᵢₙ) divided by energy output (Eₒᵤₜ) multiplied by 100.

In some examples, actual brake torque

$$( {T}_{actual}^{brake} )$$

of the EMB actuation chain 302 may not be an available measure. In such examples, the brake controller 104 may alternatively be configured to determine energy output (Eₒᵤₜ) based on Equations 6-9 below instead of using Equations 3 and 4 above.

$${E}_{out} = K {E}_{T} + K {E}_{R} + {E}_{Regen braking} - {E}_{Drag} - {E}_{Road friction} - {E}_{Grade} \qquad ( Equation 6 )$$

$$K {E}_{T} = \frac{1}{2} {M}_{v} ( {S}_{init}^{2} - {S}_{final}^{2} ) \qquad ( Equation 7 )$$

$$K {E}_{R} = \frac{1}{2} I ( {ω}_{init}^{2} - {ω}_{final}^{2} ) \qquad ( Equation 8 )$$

$$I = \frac{1}{2} {M}_{w} {r}^{2} \qquad ( Equation 9 )$$

The energy output (Eₒᵤₜ) determined using Equation 6 approximates the actual energy output (Eₒᵤₜ) using vehicle deceleration information arising from energy losses. For example, the accuracy of the approximation can be based on the accuracy of the subtracted energy losses. In Equation 6 above, energy output (Eₒᵤₜ) of the EMB actuation chain 302 is equal to the sum of translational kinetic energy of a vehicle (KE_{T}) and rotational kinetic energy of a vehicle wheel (KE_{R}) minus energy loss from regenerative braking (E_{Regen braking}), energy loss from vehicle air drag (E_{Drag}), energy loss from road friction (E_{Road friction}), and energy loss from road grade (E_{Grade}). As used herein, regenerative braking refers to the use of electrical power generator braking forces applied to a wheel to slow the wheel. For example, electrical power generated by the electrical power generator braking is sent to a vehicle battery charging system, while regenerative braking energy loss (E_{Regen braking}) contributes to slowing the wheel. As such, the amount of energy output (Eₒᵤₜ) of the EMB actuation chain 302 to slow the wheel is reduced by an energy amount resulting from the regenerative braking (E_{Regen braking}). As used herein, vehicle air drag refers to the air drag forces acting against a vehicle to reduce the vehicle's speed. As such, the amount of energy output (Eₒᵤₜ) of the EMB actuation chain 302 to slow a wheel is reduced by an energy amount resulting from the vehicle air drag (E_{Drag}). As used herein, road friction refers to the friction between a tire and a surface (e.g., a road surface, an offroad surface, etc.) that creates a resistance against a wheel's rotation. As such, the amount of energy output (Eₒᵤₜ) of the EMB actuation chain 302 to slow the wheel is reduced by an energy amount resulting from the road friction (E_{Road friction}). As used herein, road grade refers to the incline or decline of a surface (e.g., a road surface, an offroad surface, etc.). A road incline can resist forward motion of a vehicle. A road decline can contribute to forward motion of the vehicle. In such instances, the amount of energy output (Eₒᵤₜ) of the EMB actuation chain 302 to slow a wheel is reduced by an energy amount resulting from an incline road grade (E_{Grade}). Alternatively, if the road grade is at a decline, the energy loss from road grade (E_{Grade}) is negative because the decline contributes to forward vehicle motion. In such instances, the amount of energy output (Eₒᵤₜ) of the EMB actuation chain 302 to slow a wheel is increased by an energy amount from the decline road grade (E_{Grade}).

Although Equation 6 above is shown with particular types of energy loss, Equation 6 may be implemented using one or more other types of energy losses in addition to or instead of one or more of the energy loss from regenerative braking (E_{Regen braking}), the energy loss from vehicle air drag (E_{Drag}), the energy loss from road friction (E_{Road friction}), and/or the energy loss from road grade (E_{Grade}). In examples disclosed herein, tables or data structures of energy losses can be stored in the references store 510. For example, the references store 510 can store look-up tables (LUTs) that store values for each of the types of energy loss with corresponding independent parameter values that affect amounts of those energy losses. For example, energy loss values for regenerative braking (E_{Regen braking}) can be stored in association with vehicle speed values, energy loss values for vehicle air drag (E_{Drag}) can be stored in association with vehicle speed values and/or windspeed values, energy loss values for road friction (E_{Road friction}) can be stored in association with ambient temperature, vehicle speed, and/or road type, and energy loss values for road grade (E_{Grade}) can be stored in association with surface grade values. Accordingly, energy loss values for the different types of energy losses can be retrieved from the references store 510 based on corresponding independent parameter values pertinent to the environment and/or operating status of the vehicle during a braking event.

In Equation 7 above, translational kinetic energy of a vehicle (KE_{T}) is determined based on an initial vehicle speed (Sᵢₙᵢₜ) at the start of a braking event and a final vehicle speed (S_{final}) at the end of the braking event. In Equation 7, the square of the final vehicle speed

$$( {S}_{final}^{2} )$$

is subtracted from the square of the initial vehicle speed

$$( {S}_{init}^{2} )$$

to determine a difference. The translational kinetic energy of a vehicle (KE_{T}) is then determined as the product of difference and half the vehicle mass

$$( \frac{1}{2} {M}_{v} ) .$$

In Equation 8 above, rotational kinetic energy of a vehicle wheel (KE_{R}) is determined based on an initial angular velocity of the wheel (ωᵢₙᵢₜ) at the start of a braking event and a final angular velocity of the wheel (ω_{final}) at the end of the braking event. In Equation 8, the square of the final angular velocity of the wheel

$$( {ω}_{final}^{2} )$$

is subtracted from the square of the initial angular velocity of the wheel

$$( {ω}_{init}^{2} )$$

to determine a difference. The rotational kinetic energy of a vehicle wheel (KE_{R}) is then determined as the product of the difference and half the wheel inertia

$$( \frac{1}{2} I ) .$$

In Equation 9 above, the wheel inertia (I) is equal to half the wheel mass

$$( \frac{1}{2} {M}_{w} )$$

multiplied by the square of the radius of the wheel (r²). In some examples, the wheel mass (M_{w}) and the wheel radius (r) corresponding to the vehicle 100 are stored in the references store 510.

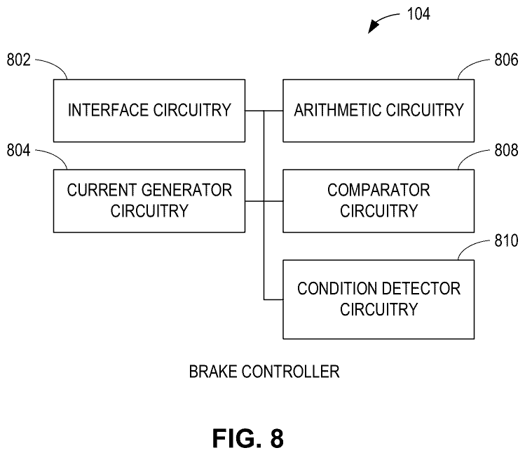

FIG. 8 is a block diagram of an example implementation of the brake controller 104 of FIGS. 1 and 5 to monitor a condition of the EMB actuation chain 302 and detect quality degradation of one or more components of the EMB actuation chain 302. The brake controller 104 of FIG. 8 may be instantiated (e.g., creating an instance of, bring into being for any length of time, materialize, implement, etc.) by programmable circuitry such as a Central Processor Unit (CPU) executing first instructions. Additionally or alternatively, the brake controller 104 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

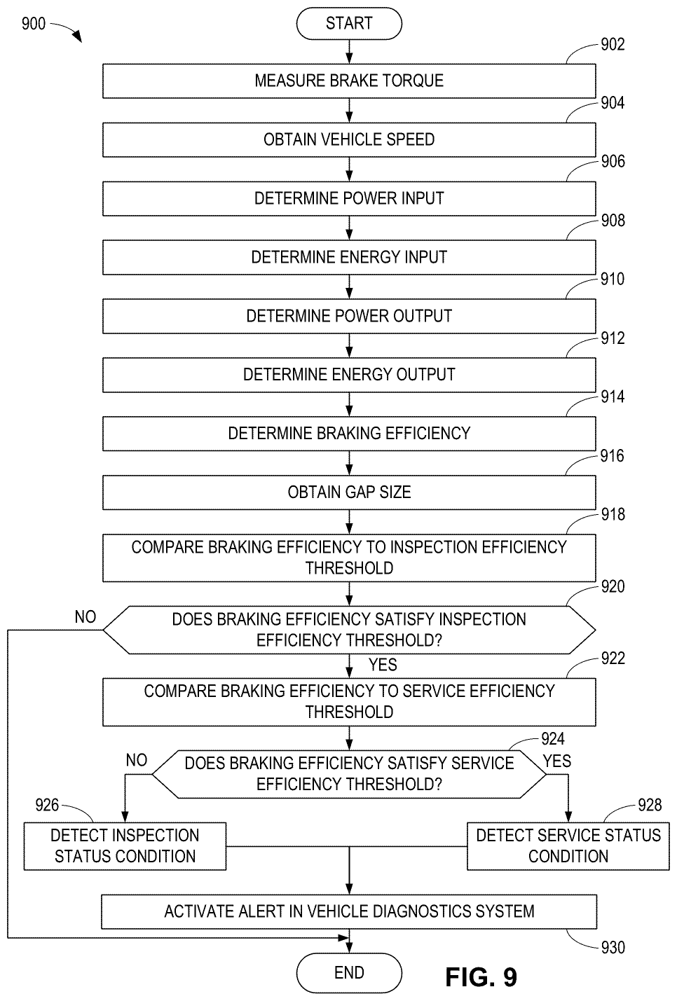

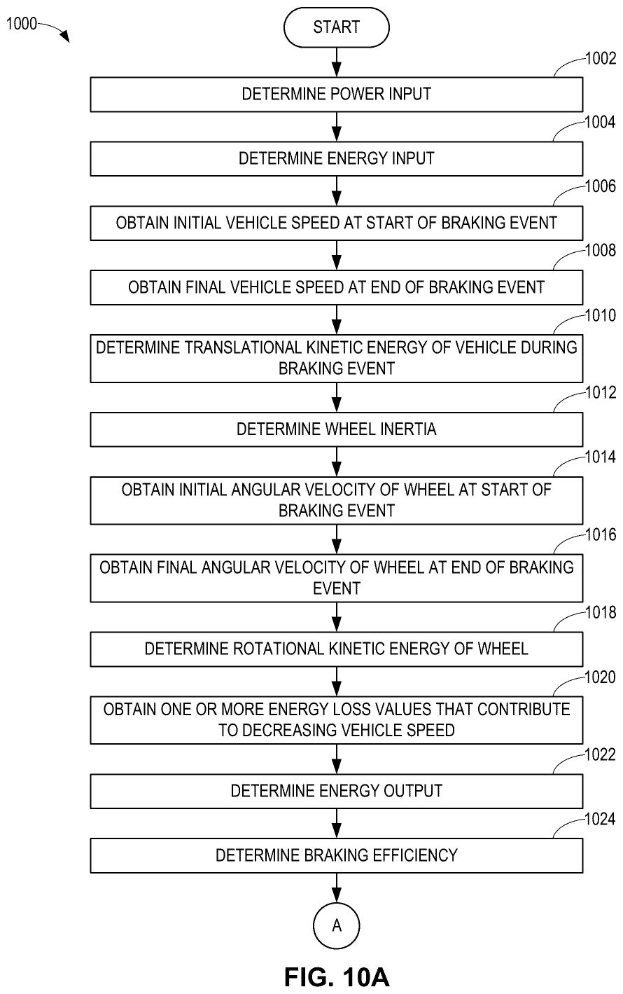

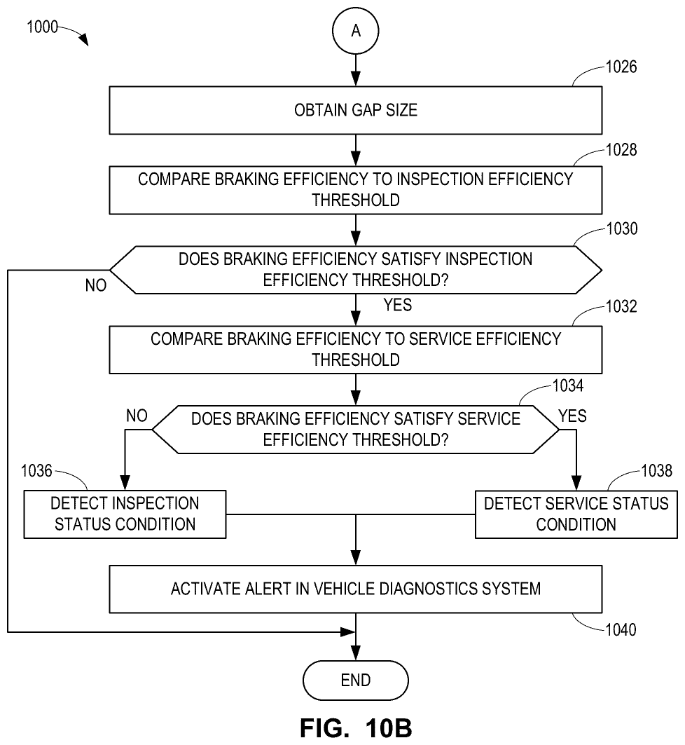

In the illustrated example of FIG. 8, the brake controller 104 includes example interface circuitry 802, example current generator circuitry 804, example arithmetic circuitry 806, example comparator circuitry 808, and example condition detector circuitry 810. The interface circuitry 802 is provided to receive input target brake torque values (Brake Torque_target) (e.g., through the pressing of a brake pedal, through an automated command of a vehicle automation system, etc.), access friction material-to-braking surface gap sizes from the gap sensor 502, access speed values from the speed sensor 508, access the I versus ΔT LUT 504 (FIG. 5), access the references store 510 (FIG. 5), and receive actual brake torque values (Brake Torque_actual) from the abutment force sensor 210 (FIGS. 2 and 5). In some examples, the interface circuitry 802 is instantiated by programmable circuitry executing interface instructions and/or configured to perform operations such as those represented by the flowchart(s) of FIG. 9 and/or FIGS. 10A and 10B.

The current generator circuitry 804 is provided to generate electrical current inputs (i_in) for the BLDC motor 402 based on electrical current values obtained from the I versus ΔT LUT 504 for corresponding input target brake torque values (Brake Torque_target). In some examples, the current generator circuitry 804 is instantiated by programmable circuitry executing current generator instructions and/or configured to perform operations such as those represented by the flowchart(s) of FIG. 9 and/or FIGS. 10A and 10B.

The arithmetic circuitry 806 is provided to perform arithmetic operations such as determining power, energy, and efficiency values based on Equations 1-9 above. In some examples, the arithmetic circuitry 806 is instantiated by programmable circuitry executing arithmetic instructions and/or configured to perform operations such as those represented by the flowchart(s) of FIG. 9 and/or FIGS. 10A and 10B.

The comparator circuitry 808 is provided to perform comparisons between data values. For example, the comparator circuitry 808 compares braking efficiency values determined using, for example, Equation 5 above with one or more efficiency thresholds such as the minimum gap inspection efficiency threshold 612, the maximum gap inspection efficiency threshold 614, the minimum gap service efficiency threshold 616, and/or the maximum gap service efficiency threshold 618 of FIG. 6. In some examples, the comparator circuitry 808 is instantiated by programmable circuitry executing comparator instructions and/or configured to perform operations such as those represented by the flowchart(s) of FIG. 9 and/or FIGS. 10A and 10B.

The condition detector circuitry 810 is provided to detect when inspection and/or service is/are due in the EMB actuation chain 302 (FIGS. 3-5). For example, the condition detector circuitry 810 can analyze comparison results of the comparator circuitry 808 to determine whether inspection and/or service is/are due for the EMB actuation chain 302. In some examples, the condition detector circuitry 810 is instantiated by programmable circuitry executing condition detector instructions and/or configured to perform operations such as those represented by the flowchart(s) of FIG. 9 and/or FIGS. 10A and 10B.

As described above, the torque comparator circuitry 506 of FIG. 5 and the interface circuitry 802, the current generator circuitry 804, the arithmetic circuitry 806, the comparator circuitry 808, and the condition detector circuitry 810 of FIG. 8 are structures. Such structures may implement means for performing corresponding disclosed functions. Examples of such functions are described above in connection with corresponding ones of the torque comparator circuitry 506, the interface circuitry 802, the current generator circuitry 804, the arithmetic circuitry 806, the comparator circuitry 808, and the condition detector circuitry 810 and are described below in connection with the flowchart(s) of FIG. 9 and/or FIGS. 10A and 10B.

While an example manner of implementing the brake controller 104 of FIG. 1 is illustrated in FIG. 8, one or more of the elements, processes, and/or devices illustrated in FIG. 8 may be combined, divided, re-arranged, omitted, eliminated, and/or implemented in any other way. Further, the torque comparator circuitry 506 of FIG. 5 and the interface circuitry 802, the current generator circuitry 804, the arithmetic circuitry 806, the comparator circuitry 808, and the condition detector circuitry 810, and/or, more generally, the brake controller 104 of FIG. 8, may be implemented by hardware alone or by hardware in combination with software and/or firmware. Thus, for example, any of the torque comparator circuitry 506 of FIG. 5 and the interface circuitry 802, the current generator circuitry 804, the arithmetic circuitry 806, the comparator circuitry 808, and the condition detector circuitry 810, and/or, more generally, the brake controller 104, could be implemented by programmable circuitry in combination with machine-readable instructions (e.g., firmware or software), processor circuitry, analog circuit(s), digital circuit(s), logic circuit(s), programmable processor(s), programmable microcontroller(s), digital signal processor(s) (DSP(s)), ASIC(s), programmable logic device(s) (PLD(s)), and/or field programmable logic device(s) (FPLD(s)) such as FPGAs. Further still, the example brake controller 104 of FIG. 8 may include one or more elements, processes, and/or devices in addition to, or instead of, those illustrated in FIG. 8, and/or may include more than one of any or all of the illustrated elements, processes and devices.

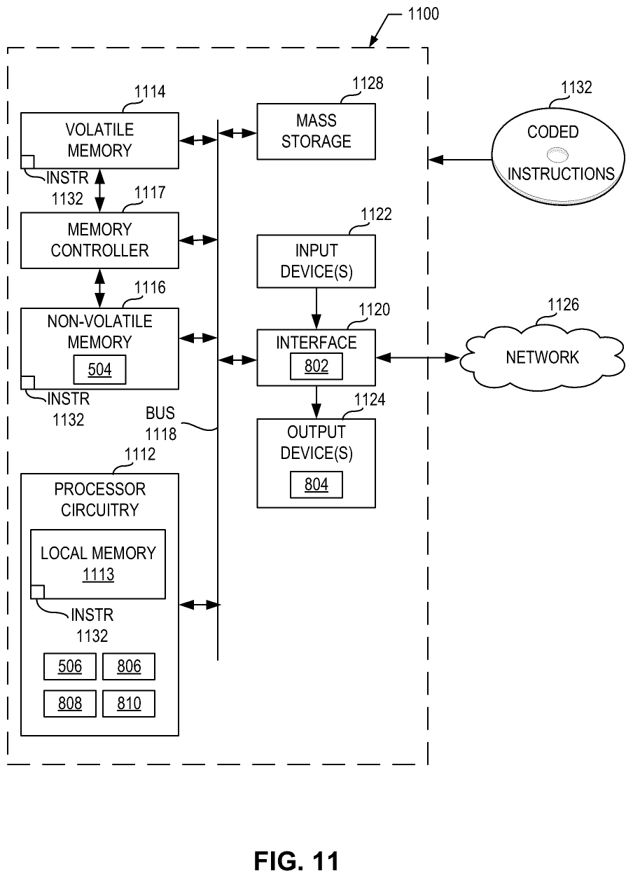

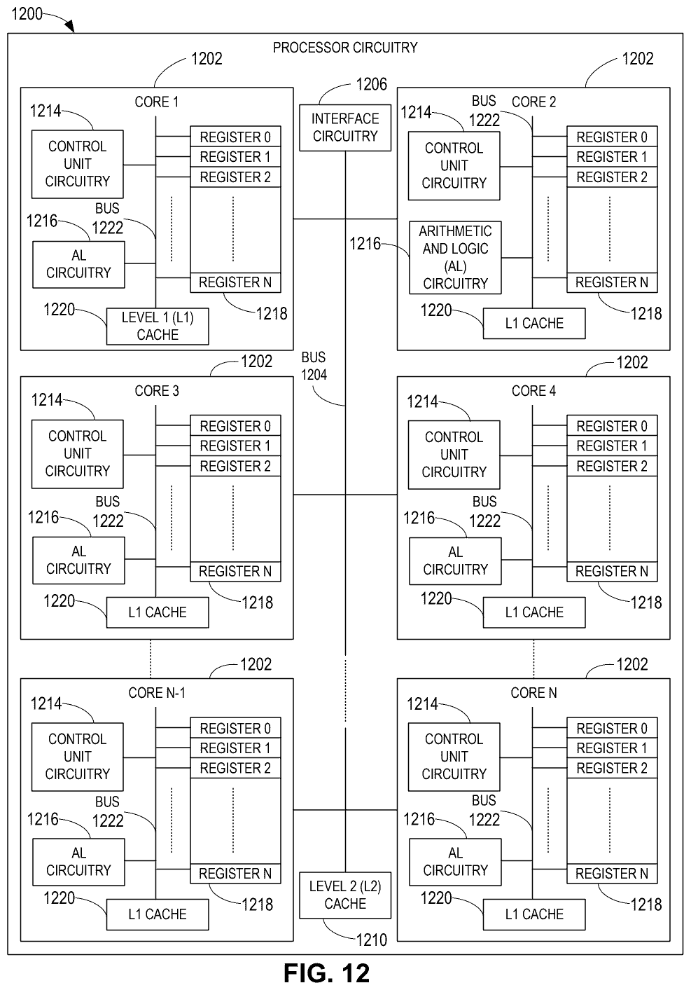

Flowcharts representative of example machine-readable instructions, which may be executed by programmable circuitry to implement and/or instantiate the brake controller 104 of FIG. 8 and/or representative of example operations which may be performed by programmable circuitry to implement and/or instantiate the brake controller 104 of FIG. 8, are shown in FIGS. 9, 10A, and 10B. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, a read-only memory (ROM), a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example programs are described with reference to the flowcharts illustrated in FIGS. 9, 10A, and 10B, many other methods of implementing the example brake controller 104 may alternatively be used. For example, the order of execution of the blocks of the flowcharts may be changed, and/or some of the blocks described may be changed, eliminated, or combined. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9, 10A, and 10B may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a ROM, a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations that may be executed, instantiated, and/or performed by example programmable circuitry (e.g., the programmable circuitry 1112 of FIG. 11) to implement the brake controller 104 of FIG. 8 to detect a condition of the EMB actuation chain 302 (FIGS. 3-5) using braking efficiency based on an actual brake torque. The machine-readable instructions and/or operations 900 can be performed for a braking event and can be repeated for multiple braking events. The machine-readable instructions and/or operations 900 are described below in connection with one braking event for one of the wheels 106a-d (FIG. 1) at which the EMB actuation system 302 is located. During the same braking event, substantially similar or identical instructions and/or operations can be performed for others of the wheels 106a-d having their respective EMB actuation systems.

The machine-readable instructions and/or operations 900 of FIG. 9 begin at block 902, at which the abutment force sensor 210 (FIG. 2) measures the actual brake torque generated by the EMB actuation chain 302. The abutment force sensor 210 can then provide the actual brake torque measure to the brake controller 104. At block 904, the interface circuitry 802 (FIG. 8) obtains the vehicle speed (S_{vehicle}) of the vehicle 100 (FIG. 1). For example, the interface circuitry 802 can obtain the vehicle speed (S_{vehicle}) from the speed sensor 508.

At block 906, the arithmetic circuitry 806 (FIG. 8) determines the power input (Pᵢₙ) of the EMB actuation chain 302. For example, the arithmetic circuitry 806 determines the electrical power input (Pᵢₙ) provided to the BLDC motor 402 (FIGS. 4 and 5) of the EMB actuation chain 302 based on Equation 1 described above. At block 908, the arithmetic circuitry 806 determines the energy input (Eᵢₙ) of the EMB actuation chain 302. For example, the arithmetic circuitry 806 determines the energy input (Eᵢₙ) of the EMB actuation chain 302 based on the electrical power input (Pᵢₙ) from block 906 and Equation 2 described above. At block 910, the arithmetic circuitry 806 determines the power output (Pₒᵤₜ) of the EMB actuation chain 302. For example, the arithmetic circuitry 806 determines the mechanical power output (Pₒᵤₜ) of the EMB actuation chain 302 based on the actual brake torque from block 902, the vehicle speed (S_{vehicle}) from block 904, and Equation 3 described above. At block 912, the arithmetic circuitry 806 determines the energy output (Eₒᵤₜ) of the EMB actuation chain 302. For example, the arithmetic circuitry 806 determines the energy output (Eₒᵤₜ) of the EMB actuation chain 302 based on the mechanical power output (Pₒᵤₜ) from block 910 and Equation 4 described above. At block 914, the arithmetic circuitry 806 determines the braking efficiency of the EMB actuation chain 302. For example, the arithmetic circuitry 806 determines the braking efficiency of the EMB actuation chain 302 based on the energy input (Eᵢₙ) from block 908, the energy output (Eₒᵤₜ) from block 912, and Equation 5 described above.

At block 916, the interface circuitry 802 obtains a friction material-to-braking surface gap size. For example, the interface circuitry 802 obtains the friction material-to-braking surface gap size between the brake shoes 204a,b (or brake pads) and a braking surface of the drum 202 (or a disc rotor) from the gap sensor 502 (FIG. 5) or from a gap size inference process. At block 918, the comparator circuitry 808 compares the braking efficiency to an inspection efficiency threshold. For example, the comparator circuitry 808 obtains an inspection efficiency threshold value from the references store 510 (FIG. 5) corresponding to the friction material-to-braking surface gap size obtained at block 916. If the friction material-to-braking surface gap size is a minimum gap, the comparator circuitry 808 obtains the minimum gap inspection efficiency threshold 612 from the references store 510. If the friction material-to-braking surface gap size is a maximum gap, the comparator circuitry 808 obtains the maximum gap inspection efficiency threshold 614 from the references store 510. If the friction material-to-braking surface gap size is between the minimum and maximum gap sizes, the comparator circuitry 808 obtains an inspection efficiency threshold corresponding to that gap size from the references store 510. In any case, the comparator circuitry 808 performs the comparison of block 918 by comparing the retrieved inspection efficiency threshold to the braking efficiency determined at block 914.

At block 920, the condition detector circuitry 810 determines whether the braking efficiency satisfies the inspection efficiency threshold. For example, the condition detector circuitry 810 determines whether the braking efficiency is less than or equal to (e.g., satisfies) the inspection efficiency threshold compared at block 918. When the condition detector circuitry 810 determines that the braking efficiency is less than or equal to the inspection efficiency threshold (block 920: YES), control advances to block 922 at which the comparator circuitry 808 compares the braking efficiency to a service efficiency threshold. For example, the comparator circuitry 808 obtains a service efficiency threshold value from the references store 510 corresponding to the friction material-to-braking surface gap size obtained at block 916. If the friction material-to-braking surface gap size is a minimum gap, the comparator circuitry 808 obtains the minimum gap service efficiency threshold 616 from the references store 510. If the friction material-to-braking surface gap size is a maximum gap, the comparator circuitry 808 obtains the maximum gap service efficiency threshold 618 from the references store 510. If the friction material-to-braking surface gap size is between the minimum and maximum gap sizes, the comparator circuitry 808 obtains a service efficiency threshold corresponding to that gap size from the references store 510. In any case, the comparator circuitry 808 performs the comparison of block 922 by comparing the retrieved service efficiency threshold to the braking efficiency determined at block 914.

At block 924, the condition detector circuitry 810 determines whether the braking efficiency satisfies the service efficiency threshold. For example, the condition detector circuitry 810 determines whether the braking efficiency is less than or equal to (e.g., satisfies) the service efficiency threshold compared at block 922. When the condition detector circuitry 810 determines that the braking efficiency is not less than or equal to (e.g., does not satisfy) the service efficiency threshold (block 924: NO), control advances to block 926 at which the condition detector circuitry 810 detects an inspection status condition for the EMB actuation chain 302. When the condition detector circuitry 810 determines that the braking efficiency is less than or equal to the service efficiency threshold (block 924: YES), control advances to block 928 at which the condition detector circuitry 810 detects a service status condition for the EMB actuation chain 302.

At block 930, the condition detector circuitry 810 activates (e.g., outputs) an alert in a vehicle diagnostics system of the vehicle 100. For example, the alert is an indication of an out-of-range condition of the EMB actuation chain 302 based on either the inspection status condition detected at block 926 or the service status condition detected at block 928. After block 930, or after the condition detector circuitry 810 determines that the braking efficiency is not less than or equal to (e.g., does not satisfy) the inspection efficiency threshold (block 920: NO), the example instructions and/or operations 900 of FIG. 9 end.

FIGS. 10A and 10B illustrate a flowchart representative of example machine-readable instructions and/or example operations 1000 that may be executed, instantiated, and/or performed by example programmable circuitry (e.g., the programmable circuitry 1112 of FIG. 11) to implement the brake controller 104 of FIG. 8 to detect a condition of the EMB actuation chain 302 (FIGS. 3-5) using braking efficiency based on kinetic energy and energy losses of the vehicle 100 (FIG. 1). The instructions and/or operations 1000 can be used when an actual brake torque (Brake Torque_actual) generated by the EMB actuation chain 302 is not available as a measure to the brake controller 104. For example, the abutment force sensor 210 (FIGS. 2, 3, and 5) does not provide the actual brake torque measure as feedback to the brake controller 104. The machine-readable instructions and/or operations 1000 can be performed for a braking event and can be repeated for multiple braking events. The machine-readable instructions and/or operations 1000 are described below in connection with one braking event for one of the wheels 106a-d (FIG. 1) at which the EMB actuation system 302 is located. During the same braking event, substantially similar or identical instructions and/or operations can be performed for others of the wheels 106a-d having their respective EMB actuation systems.

The example machine-readable instructions and/or the example operations 1000 of FIGS. 10A and 10B begin at block 1002, at which the arithmetic circuitry 806 (FIG. 8) determines the power input (Pᵢₙ) of the EMB actuation chain 302. For example, the arithmetic circuitry 806 determines the electrical power input (Pᵢₙ) provided to the BLDC motor 402 (FIGS. 4 and 5) of the EMB actuation chain 302 based on Equation 1 described above. At block 1004, the arithmetic circuitry 806 determines the energy input (Eᵢₙ) of the EMB actuation chain 302. For example, the arithmetic circuitry 806 determines the energy input (Eᵢₙ) of the EMB actuation chain 302 based on the electrical power input (Pᵢₙ) from block 1002 and Equation 2 described above. At block 1006, the interface circuitry 802 (FIG. 8) obtains an initial vehicle speed (Sᵢₙᵢₜ) of the vehicle 100 (FIG. 1) at the start of a braking event. For example, the interface circuitry 802 can obtain the initial vehicle speed (Sᵢₙᵢₜ) from the speed sensor 508. At block 1008, the interface circuitry 802 obtains a final vehicle speed of the vehicle 100 at the end of the braking event. For example, the interface circuitry 802 can obtain the final vehicle speed (S_{final}) from the speed sensor 508. When a braking event does not lead to a full stop of the vehicle 100 (e.g., the vehicle 100 was only slowed), the final vehicle speed (S_{final}) is a non-zero value. When the braking event does cause a full stop of the vehicle 100, the final vehicle speed (S_{final}) is zero.

At block 1010, the arithmetic circuitry 806 determines the translational kinetic energy (KE_{T}) of the vehicle 100 during the braking event. For example, the arithmetic circuitry 806 determines the translational kinetic energy (KE_{T}) of the vehicle 100 based on the initial vehicle speed (Sᵢₙᵢₜ) from block 1006, the final vehicle speed (S_{final}) from block 1008, and Equation 7 described above. At block 1012, the arithmetic circuitry 806 determines the wheel inertia (I) of a vehicle wheel (e.g., one of the wheels 106a-d) corresponding to the EMB actuation chain 302. For example, the arithmetic circuitry 806 determines the wheel inertia (I) using Equation 9 described above.

At block 1014, the interface circuitry 802 obtains an initial angular velocity of the wheel (ωᵢₙᵢₜ) at the start of the braking event. In some examples, the interface circuitry 802 obtains the initial angular velocity of the wheel (ωinit) directly through an angular velocity sensor (e.g., the speed sensor 508 of FIG. 5). In other examples, the arithmetic circuitry 806 determines the initial angular velocity of the wheel (ωᵢₙᵢₜ) indirectly based on linear vehicle speed. Under the indirect approach, the arithmetic circuitry 806 obtains the wheel radius (r) and the initial vehicle speed (Sᵢₙᵢₜ) and calculates the initial angular velocity of the wheel (ωᵢₙᵢₜ) by dividing the initial vehicle speed (Sᵢₙᵢₜ) by the wheel radius (r)

$$( {ω}_{init}^{2} = \frac{{S}_{init}}{r} ) .$$

In some examples, the arithmetic circuitry 806 stores the initial angular velocity of the wheel (ωᵢₙᵢₜ) in a buffer or memory from which the interface circuitry 802 retrieves the initial angular velocity of the wheel (ωᵢₙᵢₜ). At block 1016, the interface circuitry 802 obtains a final angular velocity of the wheel (ω_{final}) at the start of the braking event. For example, the interface circuitry 802 can obtain the final angular velocity of the wheel (ω_{final}) directly through an angular velocity sensor (e.g., the speed sensor 508 of FIG. 5). In other examples, the arithmetic circuitry 806 determines the final angular velocity of the wheel (ω_{final}) indirectly based on linear vehicle speed in a manner similar to what is described above for the initial angular velocity of the wheel (ωᵢₙᵢₜ). In such examples, the interface circuitry 802 may retrieve the final angular velocity of the wheel (ω_{final}) from a buffer or memory. When a braking event does not lead to a full stop of the vehicle 100 (e.g., the vehicle 100 was only slowed), the final angular velocity of the wheel (ω_{final}) is a non-zero value. When the braking event does cause a full stop of the vehicle 100, the final angular velocity of the wheel (ω_{final}) is zero.

At block 1018, the arithmetic circuitry 806 determines the rotational kinetic energy (KE_{R}) of the vehicle wheel at which the EMB actuation chain 302 is located. For example, the arithmetic circuitry 806 determines the rotational kinetic energy (KE_{R}) of the vehicle wheel based on the wheel inertia (I) from block 1012, the initial angular velocity of the wheel (ωᵢₙᵢₜ) from block 1014, the final angular velocity of the wheel (ω_{final}) from block 1016, and Equation 8 described above.

At block 1020, the interface circuitry 802 obtains one or more energy loss values that contribute to decreasing vehicle speed. For example, the interface circuitry 802 can obtain one or more of the energy loss values described above in connection with Equation 6 from the references store 510 (FIG. 5). At block 1022, the arithmetic circuitry 806 determines the energy output (Eₒᵤₜ) of the EMB actuation chain 302. For example, the arithmetic circuitry 806 determines the energy output (Eₒᵤₜ) of the EMB actuation chain 302 based on the translational kinetic energy (KE_{T}) from block 1010, the rotational kinetic energy (KE_{R}) from block 1018, the one or more energy losses from block 1020, and Equation 6 described above. At block 1024, the arithmetic circuitry 806 determines the braking efficiency of the EMB actuation chain 302. For example, the arithmetic circuitry 806 determines the braking efficiency of the EMB actuation chain 302 based on the energy input (Eᵢₙ) from block 1004, the energy output (Eₒᵤₜ) from block 1022, and Equation 5 described above.

At block 1026, the interface circuitry 802 obtains a friction material-to-braking surface gap size. For example, the interface circuitry 802 obtains the friction material-to-braking surface gap size between the brake shoes 204a,b (or brake pads) and a braking surface of the drum 202 (or a disc rotor) from the gap sensor 502 or from a gap size inference process. At block 1028, the comparator circuitry 808 compares the braking efficiency to an inspection efficiency threshold. For example, the comparator circuitry 808 obtains an inspection efficiency threshold value from the references store 510 corresponding to the friction material-to-braking surface gap size obtained at block 1026. If the friction material-to-braking surface gap size is a minimum gap, the comparator circuitry 808 obtains the minimum gap inspection efficiency threshold 612 from the references store 510. If the friction material-to-braking surface gap size is a maximum gap, the comparator circuitry 808 obtains the maximum gap inspection efficiency threshold 614 from the references store 510. If the friction material-to-braking surface gap size is between the minimum and maximum gap sizes, the comparator circuitry 808 obtains an inspection efficiency threshold corresponding to that gap size from the references store 510. In any case, the comparator circuitry 808 performs the comparison of block 1028 by comparing the retrieved inspection efficiency threshold to the braking efficiency determined at block 1024.

At block 1030, the condition detector circuitry 810 determines whether the braking efficiency satisfies the inspection efficiency threshold. For example, the condition detector circuitry 810 determines whether the braking efficiency is less than or equal to (e.g., satisfies) the inspection efficiency threshold compared at block 1028. When the condition detector circuitry 810 determines that the braking efficiency is less than or equal to the inspection efficiency threshold (block 1030: YES), control advances to block 1032 at which the comparator circuitry 808 compares the braking efficiency to a service efficiency threshold. For example, the comparator circuitry 808 obtains a service efficiency threshold value from the references store 510 corresponding to the friction material-to-braking surface gap size obtained at block 1026. If the friction material-to-braking surface gap size is a minimum gap, the comparator circuitry 808 obtains the minimum gap service efficiency threshold 616 from the references store 510. If the friction material-to-braking surface gap size is a maximum gap, the comparator circuitry 808 obtains the maximum gap service efficiency threshold 618 from the references store 510. If the friction material-to-braking surface gap size is between the minimum and maximum gap sizes, the comparator circuitry 808 obtains a service efficiency threshold corresponding to that gap size from the references store 510. In any case, the comparator circuitry 808 performs the comparison of block 1032 by comparing the retrieved service efficiency threshold to the braking efficiency determined at block 1024.

At block 1034, the condition detector circuitry 810 determines whether the braking efficiency satisfies the service efficiency threshold. For example, the condition detector circuitry 810 determines whether the braking efficiency is less than or equal to (e.g., satisfies) the service efficiency threshold compared at block 1032. When the condition detector circuitry 810 determines that the braking efficiency is not less than or equal to (e.g., does not satisfy) the service efficiency threshold (block 1034: NO), control advances to block 1036 at which the condition detector circuitry 810 detects an inspection status condition for the EMB actuation chain 302. When the condition detector circuitry 810 determines that the braking efficiency is less than or equal to the service efficiency threshold (block 1034: YES), control advances to block 1038 at which the condition detector circuitry 810 detects a service status condition for the EMB actuation chain 302.

At block 1040, the condition detector circuitry 810 activates (e.g., outputs) an alert in a vehicle diagnostics system of the vehicle 100. For example, the alert is an indication of an out-of-range condition of the EMB actuation chain 302 based on either the inspection status condition detected at block 1036 or the service status condition detected at block 1038. After block 1040, or after the condition detector circuitry 810 determines that the braking efficiency is not less than or equal to (e.g., does not satisfy) the inspection efficiency threshold (block 1030: NO), the example instructions and/or operations 1000 of FIG. 10 end.

FIG. 11 is a block diagram of an example programmable circuitry platform 1100 structured to execute and/or instantiate the example machine-readable instructions and/or the example operations of FIGS. 9, 10A, and 10B to implement the brake controller 104 of FIG. 8. The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, DSPs, and/or microcontrollers from any desired family or manufacturer. The programmable circuitry 1112 may be implemented by one or more semiconductor based (e.g., silicon based) devices. In this example, the programmable circuitry 1112 implements the torque comparator circuitry 506 of FIG. 5 and the arithmetic circuitry 806, the comparator circuitry 808, and the condition detector circuitry 810 of FIG. 8.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116. In the illustrated example, the I versus ΔT LUT 504 is stored in the non-volatile memory 1116. Additionally or alternatively, the I versus ΔT LUT 504 may be stored in the volatile memory 1114.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1120 is in communication with an example network 1126. In the illustrated example, the interface circuitry 1120 implements the interface circuitry 802 of FIG. 8.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, a brake pedal, a brake lever, a button, an in-vehicle graphical user interface, a vehicle automation system application programming interface (API), etc.

One or more output devices 1124 are also connected to the interface circuitry 1120 of the illustrated example. In the illustrate example, the output device(s) 1124 implement the current generator circuitry 804 to generate and provide electrical current inputs (i_in) to the BLDC motor 402.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.) and/or solid-state storage discs or devices such as flash memory devices and/or SSDs. In some examples, the I versus ΔT LUT 504 is stored the mass storage device 1128 in addition to or instead of the volatile memory 1114 and/or the non-volatile memory 1116.

The machine-readable instructions 1132, which may be implemented by the machine-readable instructions of FIGS. 9, 10A, and 10B, may be stored in the mass storage device 1128, in the volatile memory 1114, in the non-volatile memory 1116, and/or on at least one non-transitory computer-readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9, 10A, and 10B to effectively instantiate the circuitry of FIG. 8 as logic circuits to perform operations corresponding to those machine-readable instructions. In some such examples, the circuitry of FIG. 8 is instantiated by the hardware circuits of the microprocessor 1200 in combination with the machine-readable instructions. For example, the microprocessor 1200 may be implemented by multi-core hardware circuitry such as a CPU, a DSP, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 9, 10A, and 10B.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), general-purpose register(s), flag register(s), segment register(s), machine-specific register(s), instruction pointer register(s), control register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

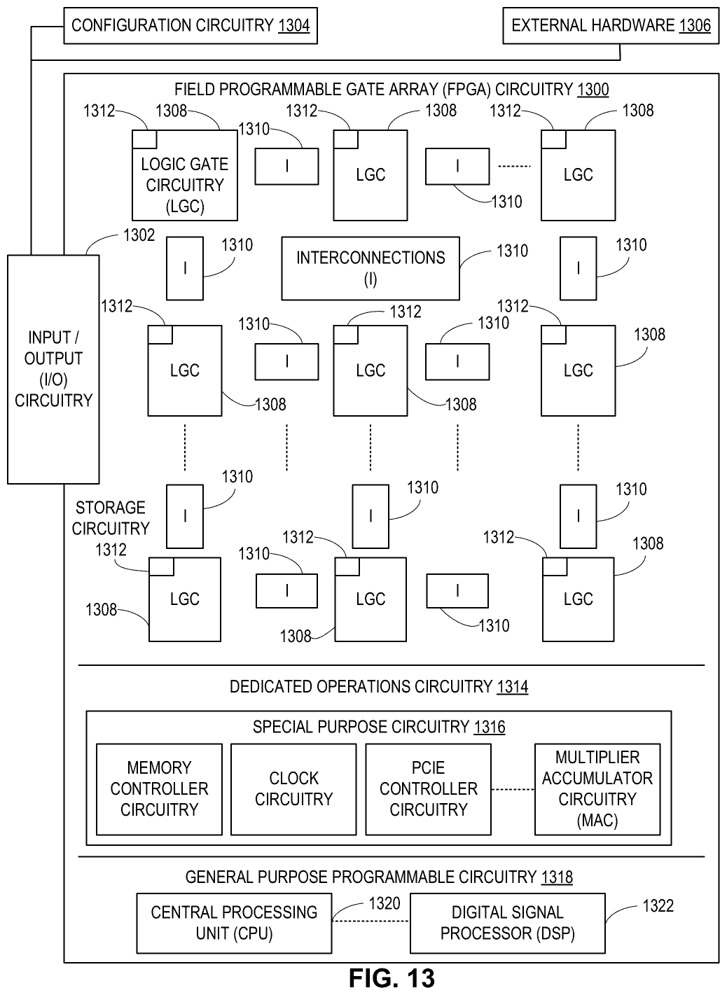

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowcharts of FIGS. 9, 10A, and 10B but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 9, 10A, and 10B. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 9, 10A, and 10B. As such, the FPGA circuitry 1300 may be configured and/or structured to effectively instantiate some or all of the operations/functions corresponding to the machine-readable instructions of the flowcharts of FIGS. 9, 10A, and 10B as dedicated logic circuits to perform the operations/functions corresponding to those software instructions in a dedicated manner analogous to an ASIC. Therefore, the FPGA circuitry 1300 may perform the operations/functions corresponding to some or all of the machine-readable instructions of FIGS. 9, 10A, and 10B faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 9, 10A, and 10B and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions so that those functions do not need to be programmed in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowcharts of FIGS. 9, 10A, and 10B to perform first operation(s)/function(s), the FPGA circuitry 1300 of FIG. 13 may be configured and/or structured to perform second operation(s)/function(s) corresponding to a second portion of the machine-readable instructions represented by the flowcharts of FIGS. 9, 10A, and 10B, and/or an ASIC may be configured and/or structured to perform third operation(s)/function(s) corresponding to a third portion of the machine-readable instructions represented by the flowcharts of FIGS. 9, 10A, and 10B.

It should be understood that some or all of the circuitry of FIG. 8 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 8 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Digital Signal Processors (DSPs) that may execute first instructions to perform one or more operations and/or functions, one or more microcontrollers that may execute first instructions to perform one or more operations and/or functions and/or integrated circuits such as Application Specific Integrated Circuits (ASICs).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to monitor a condition of a braking system are disclosed herein. Further examples and combinations thereof include the following:

Example 1 includes an apparatus comprising machine-readable instructions, and at least one processor circuit to be programmed by the machine-readable instructions to measure, via a sensor, a brake torque generated by a braking system, determine an energy output of the braking system based on a mechanical power output of the braking system, the mechanical power output based on the brake torque, determine an efficiency based on the energy output and an energy input, the energy input corresponding to an electrical power input of a motor of the braking system, detect a condition of the braking system based on the efficiency, and output an indication representative of the condition.

Example 2 includes the apparatus of example 1, wherein one or more of the at least one processor circuit is to output the indication as an out-of-range condition of the braking system.

Example 3 includes the apparatus of example 1 and/or example 2, wherein one or more of the at least one processor circuit is to determine the energy input based on the electrical power input of the motor over a duration of a braking event, the electrical power input to change over the duration in response to increased motor resistance.

Example 4 includes the apparatus of any one or more of examples 1-3, wherein one or more of the at least one processor circuit is to determine the energy output of the braking system based on the mechanical power output of the braking system over a duration of a braking event.

Example 5 includes the apparatus of any one or more of examples 1-4, wherein one or more of the at least one processor circuit is to determine the mechanical power output by determining a product of the brake torque and a vehicle speed, and dividing the product by a wheel radius.

Example 6 includes the apparatus of any one or more of examples 1-5, wherein one or more of the at least one processor circuit is to detect the condition by comparing the efficiency to a threshold corresponding to a gap size between a friction material and a braking surface of the braking system.

Example 7 includes the apparatus of any one or more of examples 1-6, wherein the one or more of the at least one processor circuit is to obtain the gap size from a gap sensor.

Example 8 includes at least one non-transitory machine-readable medium comprising machine-readable instructions to cause at least one processor circuit to at least measure, via a sensor, a first speed and a second speed of a vehicle, the first speed corresponding to a start of a braking event, the second speed corresponding to an end of the braking event, determine an energy output of a braking system based on the first speed and the second speed, determine an efficiency based on the energy output and an energy input, the energy input corresponding to an electrical power input of a motor of the braking system, detect a condition of the braking system based on the efficiency, and output an indication representative of the condition.

Example 9 includes the at least one non-transitory machine-readable medium of example 8, wherein the machine-readable instructions are to cause one or more of the at least one processor circuit to output the indication as an out-of-range condition of the braking system.

Example 10 includes the at least one non-transitory machine-readable medium of example 8 and/or example 9, wherein the machine-readable instructions are to cause one or more of the at least one processor circuit to determine the energy input based on the electrical power input of the motor over a duration of the braking event, the electrical power input to change over the duration based on increasing temperature of windings of the motor.

Example 11 includes the at least one non-transitory machine-readable medium of any one or more of examples 8-10, wherein the machine-readable instructions are to cause one or more of the at least one processor circuit to determine the energy output of the braking system based on energy loss from at least one of regenerative braking, air drag, or road friction.

Example 12 includes the at least one non-transitory machine-readable medium of any one or more of examples 8-11, wherein the machine-readable instructions are to cause one or more of the at least one processor circuit to detect the condition by comparing the efficiency to a threshold corresponding to a gap size between a friction material and a braking surface of the braking system.

Example 13 includes the at least one non-transitory machine-readable medium of any one or more of examples 8-12, wherein the machine-readable instructions are to cause the one or more of the at least one processor circuit to obtain the gap size from a gap sensor.

Example 14 includes a method comprising measuring, via a sensor, a brake torque generated by a braking system, determining an energy output of the braking system based on a mechanical power output of the braking system, the mechanical power output based on the brake torque, determining an efficiency based on the energy output and an energy input, the energy input corresponding to an electrical power input of a motor of the braking system, detecting, by at least one processor circuit programmed by at least one instruction, a condition of the braking system based on the efficiency, and outputting an indication representative of the condition.

Example 15 includes the method of example 14, wherein the outputting of the indication includes outputting the indication as an out-of-range condition of the braking system.

Example 16 includes the method of example 14 and/or example 15, further comprising determining the energy input based on the electrical power input of the motor over a duration of a braking event, the electrical power input to change over the duration in response to increased motor resistance.

Example 17 includes the method of any one or more of examples 14-16, wherein the determining of the energy output of the braking system is based on the mechanical power output of the braking system over a duration of a braking event.

Example 18 includes the method of any one or more of examples 14-17, further including determining the mechanical power output by determining a product of the brake torque and a vehicle speed, and dividing the product by a wheel radius.

Example 19 includes the method of any one or more of examples 14-18, wherein the detecting of the condition includes comparing the efficiency to a threshold corresponding to a gap size between a friction material and a braking surface of the braking system.

Example 20 includes the method of any one or more of examples 14-19, further including obtaining the gap size from a gap sensor.

From the foregoing, it will be appreciated that example systems, apparatus, articles of manufacture, and methods have been disclosed that monitor a condition of a braking system. Disclosed systems, apparatus, articles of manufacture, and methods monitor the condition of components of an EMB actuation chain based on braking efficiencies of the EMB actuation chain. Disclosed systems, apparatus, articles of manufacture, and methods are accordingly directed to operations of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine-readable instructions; and
at least one processor circuit to be programmed by the machine-readable instructions to:
measure, via a sensor, a brake torque generated by a braking system;
determine an energy output of the braking system based on a mechanical power output of the braking system, the mechanical power output based on the brake torque;
determine an efficiency based on the energy output and an energy input, the energy input corresponding to an electrical power input of a motor of the braking system;
detect a condition of the braking system based on the efficiency; and
output an indication representative of the condition.

2. The apparatus of claim 1, wherein one or more of the at least one processor circuit is to output the indication as an out-of-range condition of the braking system.

3. The apparatus of claim 1, wherein one or more of the at least one processor circuit is to determine the energy input based on the electrical power input of the motor over a duration of a braking event, the electrical power input to change over the duration in response to increased motor resistance.

4. The apparatus of claim 1, wherein one or more of the at least one processor circuit is to determine the energy output of the braking system based on the mechanical power output of the braking system over a duration of a braking event.

5. The apparatus of claim 1, wherein one or more of the at least one processor circuit is to determine the mechanical power output by:
determining a product of the brake torque and a vehicle speed; and
dividing the product by a wheel radius.

6. The apparatus of claim 1, wherein one or more of the at least one processor circuit is to detect the condition by comparing the efficiency to a threshold corresponding to a gap size between a friction material and a braking surface of the braking system.

7. The apparatus of claim 6, wherein the one or more of the at least one processor circuit is to obtain the gap size from a gap sensor.

8. At least one non-transitory machine-readable medium comprising machine-readable instructions to cause at least one processor circuit to at least:
measure, via a sensor, a first speed and a second speed of a vehicle, the first speed corresponding to a start of a braking event, the second speed corresponding to an end of the braking event;
determine an energy output of a braking system based on the first speed and the second speed;
determine an efficiency based on the energy output and an energy input, the energy input corresponding to an electrical power input of a motor of the braking system;
detect a condition of the braking system based on the efficiency; and
output an indication representative of the condition.

9. The at least one non-transitory machine-readable medium of claim 8, wherein the machine-readable instructions are to cause one or more of the at least one processor circuit to output the indication as an out-of-range condition of the braking system.

10. The at least one non-transitory machine-readable medium of claim 8, wherein the machine-readable instructions are to cause one or more of the at least one processor circuit to determine the energy input based on the electrical power input of the motor over a duration of the braking event, the electrical power input to change over the duration based on increasing temperature of windings of the motor.

11. The at least one non-transitory machine-readable medium of claim 8, wherein the machine-readable instructions are to cause one or more of the at least one processor circuit to determine the energy output of the braking system based on energy loss from at least one of regenerative braking, air drag, or road friction.

12. The at least one non-transitory machine-readable medium of claim 8, wherein the machine-readable instructions are to cause one or more of the at least one processor circuit to detect the condition by comparing the efficiency to a threshold corresponding to a gap size between a friction material and a braking surface of the braking system.

13. The at least one non-transitory machine-readable medium of claim 12, wherein the machine-readable instructions are to cause the one or more of the at least one processor circuit to obtain the gap size from a gap sensor.

14. A method comprising:
measuring, via a sensor, a brake torque generated by a braking system;
determining an energy output of the braking system based on a mechanical power output of the braking system, the mechanical power output based on the brake torque;
determining an efficiency based on the energy output and an energy input, the energy input corresponding to an electrical power input of a motor of the braking system;
detecting, by at least one processor circuit programmed by at least one instruction, a condition of the braking system based on the efficiency; and
outputting an indication representative of the condition.

15. The method of claim 14, wherein the outputting of the indication includes outputting the indication as an out-of-range condition of the braking system.

16. The method of claim 14, further comprising determining the energy input based on the electrical power input of the motor over a duration of a braking event, the electrical power input to change over the duration in response to increased motor resistance.

17. The method of claim 14, wherein the determining of the energy output of the braking system is based on the mechanical power output of the braking system over a duration of a braking event.

18. The method of claim 14, further including determining the mechanical power output by:
determining a product of the brake torque and a vehicle speed; and
dividing the product by a wheel radius.

19. The method of claim 14, wherein the detecting of the condition includes comparing the efficiency to a threshold corresponding to a gap size between a friction material and a braking surface of the braking system.

20. The method of claim 19, further including obtaining the gap size from a gap sensor.
